(19) United States
(12) Patent Application Publication
(10) Pub. No.: US 2025/0286773 A1
(43) Pub. Date: Sep. 11, 2025

(54) METHODS AND SYSTEMS FOR NETWORK COVERAGE

(71) Applicant: Comcast Cable Communications, LLC, Philadelphia, PA (US)

(72) Inventors: Jonathan Cave, Philadelphia, PA (US); Olakunle Ekundare, Philadelphia, PA (US); Leon Venton, Philadelphia, PA (US); Alberto Garcia-Ortiz, Philadelphia, PA (US); Christopher Stone, Philadelphia, PA (US); Naveen Kumar Raju Vysyaraju, Philadelphia, PA (US); Mark Paulits, Philadelphia, PA (US)

(21) Appl. No.: 18/595,816

(22) Filed: Mar. 5, 2024

(51) Int. Cl. H04L 41/0663; H04L 12/46

(52) U.S. Cl. CPC H04L 41/0663; H04L 12/4633

(57) ABSTRACT

Methods, apparatuses, and systems are described for providing back-up access to a wide area network such as the Internet during network and/or power outages. Based on determining a network outage and/or a power outage, a network device may be configured to assume one or more gateway functions to provide access to the wide area network during the network outage and/or the power outage.

### BACKGROUND

A network such as a local area network may comprise a Wi-Fi access point (AP) for providing access to one or more user devices to a wide area network such as the Internet. However, network and power outages can affect users' ability to access the Internet. Unfortunately, the only method to access the Internet during network and/or power outages requires the use of a cellular phone or separate access device capable of providing network coverage during the network and/or power outages. These devices essentially provide cellular back-up to users during the network and/or power outages. However, these devices only operate as a Wi-Fi Extender when not in back-up mode.

### SUMMARY

It is to be understood that both the following general description and the following detailed description are examples and explanatory only and are not restrictive. Methods, systems, and apparatuses for providing back-up network coverage are disclosed.

A network device may be configured to provide back-up access to a wide area network such as the Internet during network and/or power outages. One or more user devices may be connected to a gateway device prior to the network/power outage in order to receive access to the wide area network. The network device may determine a network outage and/or a power outage associated with the gateway device that initially provides the access to the wide area network via a local network. Based on the network outage, the network device may establish a network path, such as a wide area network tunnel, between the network device and the gateway device to provide access to the wide area network to the gateway device. The network device may maintain access to the wide area network for the one or more user devices via the network path with the gateway device. Based on the power outage, the network device may establish a connection with the one or more user devices, assuming the role of the gateway device, to provide access to the wide area network to the one or more user devices.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 shows an example system for extending network coverage;

FIG. 2 shows an example scenario for extending network coverage;

FIG. 3 shows an example scenario for extending network coverage;

FIG. 4 shows an example scenario for extending network coverage;

FIG. 5 shows an example scenario for extending network coverage;

FIG. 6 shows a flowchart of an example method;

FIG. 7 shows a flowchart of an example method;

FIG. 8 shows a flowchart of an example method; and

FIG. 9 shows a block diagram of an example system and computing device.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

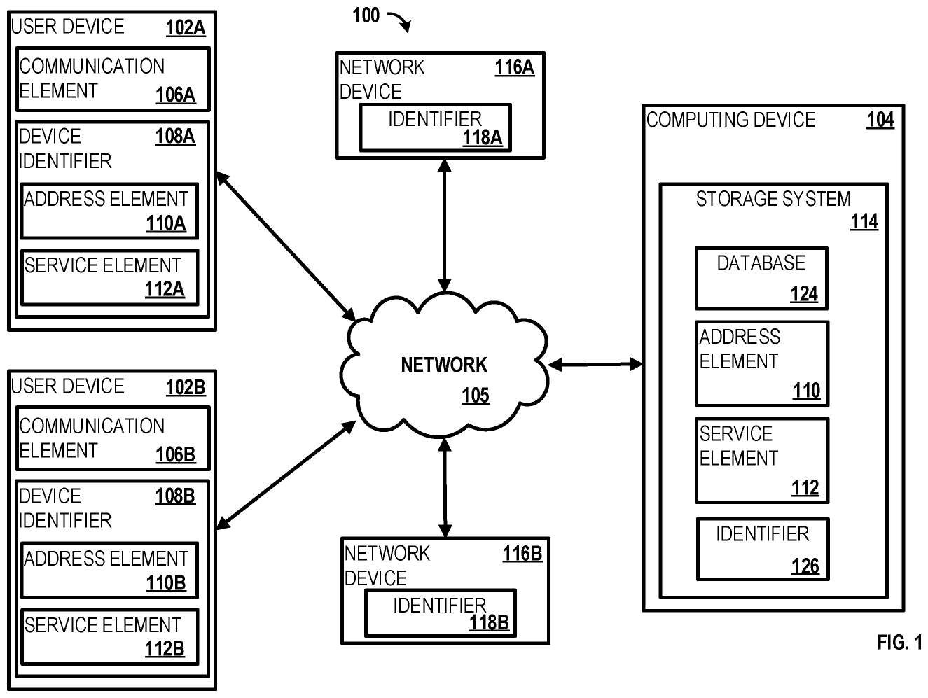

FIG. 1 shows an example system 100 for providing back-up network coverage. For example, the system 100 may be configured to determine a network outage and/or a power outage and provide back-up access to a wide area network (e.g., the Internet) during the network outage and/or the power outage. The network and system 100 may be configured to provide services, such as network-related services, to a device (e.g., devices 102A-102B). The system 100 may comprise one or more devices 102A-102B in communication with a plurality of network devices 116A-116B, such as a wireless access point (e.g., gateway device) and/or a LTE back-up device, for example. The computing device 104 may be disposed locally or remotely relative to the devices 102A-102B. The network devices 116A-116B may facilitate access to the network 105 for one or more devices 102 and/or the computing device 104. For example, the devices 102A-102B and the computing device 104 may be in communication via a private and/or public network 105 such as the Internet or a local area network (LAN) via the network devices 116A-116B. The network devices 116A-116B may be in communication with a computing device 104 such as a centralized device or a server, for example. Other forms of communications can be used such as wired and wireless telecommunication channels.

The devices 102A-102B may comprise electronic devices such as a computer, a smartphone, a laptop, a tablet, a set top box, a display device, a printer, a telephone, a cordless phone, a network node, a network device, a communication terminal, a transmitter, or other device capable of communicating with the network devices 116A-116B. As an example, the devices 102A-102B may comprise communication elements 106A-106B for offering an interface to a user to interact with the devices 102A-102B and/or the computing device 104. The communication element 106A-106B can be any interface for presenting and/or receiving information to/from the user, such as media content. An example interface may be a communication interface such as a web browser (e.g., Internet Explorer®, Mozilla Firefox®, Google Chrome®, Safari®, or the like). Other software, hardware, and/or interfaces can be used to facilitate communication between the user and one or more of the devices 102A-102B and the network devices 116A-116B. As an example, the communication elements 106A-106B can request or query various files from a local source and/or a remote source. As an example, the communication element 106A-106B can transmit data to a local or remote device such as the network devices 116A-116B or the computing device 104 via the network devices 116A-116B.

The devices 102A-102B may be associated with user identifiers or device identifiers 108A-108B. As an example, the device identifiers 108A-108B may be any identifier, token, character, string, or the like, for differentiating one user or user device (e.g., a user device 102A) from another user or user device. The device identifier 108A-108B may identify a user or user device as belonging to a particular class of users or user devices. As an example, the device identifier 108A-108B may comprise information relating to the user device such as a manufacturer, a model or type of device, a service provider associated with the device 102A-102B, a state of the device 102A-102B, a locator, and/or a label or classifier. Other information can be represented by the device identifiers 108A-108B.

The device identifiers 108A-108B may comprise address elements 110A-110B and service elements 112A-112B. The address elements 110A-110B may comprise or make available an internet protocol address, a network address, a media access control (MAC) address, an Internet address, or the like. As an example, the address elements 110A-110B may be relied upon to establish a communication session between the devices 102A-102B and the network devices 116A-116B or other devices and/or networks. As an example, the address elements 110A-110B may be used as an identifier or locator of the user devices 102A-102B. The address elements 110A-110B may be persistent for a particular network.

The service elements 112A-112B may comprise identification of the service providers associated with the devices 102A-102B and/or with the class of devices 102A-102B. The class of the devices 102A-102B may be related to a type of device, a capability of a device, a type of service being offered, and/or a level of service (e.g., a business class, a service tier, a service package, etc.). As an example, the service elements 112A-112B may comprise information relating to or made available by a communication service provider (e.g., an Internet service provider) that is offering or enabling data flow such as communication services to the devices 102A-102B. As an example, the service elements 112A-112B may comprise information relating to a preferred service provider for one or more particular services relating to the devices 102A-102B. The address elements 110A-110B may be used to identify or retrieve data from the service elements 112A-112B, or vice-versa. As an example, one or more of the address elements 110A-110B and the service elements 112A-112B can be stored remotely from the devices 102A-102B and retrieved by one or more devices such as the devices 102A-102B and the computing device 104. Other information can be represented by the service element 112A-112B.

A plurality of network devices 116A-116B may be in communication with a network, such as network 105. The network devices 116A-116B may be configured to allow one or more wireless devices to connect to a wired and/or wireless network using Wi-Fi, Bluetooth®, Zigbee®, or any desired method or standard. As an example, one or more of the network devices 116A-116B may be configured to facilitate the connection of a device, such as the device 102A-102B, to the network 105. The network device 116A may be configured as a wireless access point (WAP) to provide access to a wide area network (e.g., the Internet). For example, the network device 116A may be configured to access the wide area network via a computing device (e.g., computing device 104, server, headend, Internet service provider, etc.). The network device 116A may be configured to perform one or more gateway functions in order to provide the access to the wide area network. The one or more gateway functions may comprise one or more of network traffic routing, dynamic host configuration protocol (DHCP) management, VOIP functions, or IP streaming functions. The network device 116B may be configured as a Wi-Fi extender for extending the coverage of the local network. In an example, the network devices 116A-116B may be configured as a local network (e.g., local area network (LAN)) to provide, to the devices 102A-102B access to the wide area network via the local network. The network device 116B may determine (e.g., detect) a network outage and/or a power outage. The network device 116B may be configured to provide back-up access to the wide area network during the network outage and/or the power outage based on accessing the wide area network via an alternative Internet service provider. For example, the network device 116B may be configured to access the wide area network via one or more alternative Internet service providers such as a LTE Internet service provider, a cellular Internet service provider, a DSL Internet service provider, a satellite Internet service provider, combinations thereof, and the like.

During a network outage, the network device 116B may establish a network path between the network device 116A and the network device 116B in order to provide, to the network device 116A, access to the wide area network via the network path. For example, the network path may comprise a wide area network tunnel. The network device 116B may be configured to maintain a previously existing local area network tunnel between the network device 116A and the network device 116B and create the wide area network tunnel in order to enable the network device 116A to maintain providing access to the wide area network for the one or more devices 102A-102B connected to the network device 116A. The network device 116B may be configured to provide the access to the wide area network based on performing the one or more gateway functions of the network device 116A during the network outage. For example, the network device 116B may be configured to assume (e.g., take over) the one or more gateway functions of the network device 116A to provide access to the wide area network to the network device 116A during the network outage. For example, the first network device may assume the role of the network device 116A with respect to the one or more gateway functions (e.g., network traffic routing, DHCP management, VoIP functions, or IP streaming functions) during the network outage. The network device 116B may be configured to determine/detect the network outage based on one or more of an absence of network data packets from the network device 116A, an absence of one or more signals from the network device 116A, or a message from the network device 116A.

During a power outage, the network device 116B may assume the role of the network device 116A and provide, to the devices 102A-102B, access to the wide area network via the local network. The network device 116A may initially provide, to the devices 102A-102B, access to the wide area network according to one or more network addresses assigned by the network device 116A to the devices 102A-102B to facilitate the devices' 102A-102B connection to the wide area network. The network device 116B may be configured to maintain (e.g., store) a record of the one or more network addresses assigned to the devices 102A-102B by the network device 116A. The network device 116B may provide, to the devices 102A-102B, access to the wide area network according to the one or more addresses initially assigned to the devices 102A-102B by the network device 116A during the power outage. The network device 116B may be configured to provide the access to the wide area network based on performing the one or more gateway functions of the devices 102A-102B during the power outage. For example, the network device 116B may be configured to assume the role of the network device 116A and assume (e.g., take over) the one or more gateway functions of the network device 116A to provide access to the wide area network to the network device 116A. In an example, the network device 116A may be configured with a service set identifier (SSID) for facilitating the devices' 102A-102B connection to the wide area network. The network device 116B may be configured with the same SSID as the network device 116A to facilitate the connection to the wide area network during the power outage. For example, the one or more devices 102A-102B would automatically connect to the network device 116B via the SSID during the power outage. The network device 116B may be configured to determine the power outage based on an absence of network data packets from the network device 116A, an absence of one or more signals from the network device 116A, or a battery of the network device 116B is no longer charging.

The network devices 116A-116B may comprise identifiers 118A-118B. As an example, one or more identifiers can be or relate to an Internet Protocol (IP) Address IPV4/IPV6 or a media access control address (MAC address) or the like. As a further example, the identifiers 118A-118B may be unique identifiers for facilitating communications on the physical network segment. Each of the network devices 116A-116B may comprise an identifier 118 that is distinct. As an example, the identifiers 118A-118B may be associated with a physical location of the network devices 116A-116B.

The computing device 104 may comprise a server, or a centralized device, for communicating with the network devices 116A-116B, or the devices 102A-102B via the network devices 116A-116B. In an example, the computing device 104 may communicate with the devices 102A-102B for offering data and/or services. For example, the computing device 104 may offer services such as network (e.g., Internet) connectivity, network printing, media management (e.g., a media server), interference management, content services, streaming services, broadband services, or other network-related services.

The computing device 104 may allow the user devices 102A-102B to interact with remote resources such as data, devices, and files. As an example, the computing device 104 may be configured as (or disposed at) a central location (e.g., a headend, or a processing facility), which can receive content (e.g., data, input programming) from multiple sources. The computing device 104 may be a separate/remote device from the headend, for example. The computing device 104 can combine content from the multiple sources and may distribute the content to user (e.g., subscriber) locations via a distribution system.

The computing device 104 may be configured to manage the communication between the devices 102A-102B and a storage system 114 for sending and receiving data therebetween. As an example, the storage system 114 can store a plurality of files, user identifiers or records, or other information. As a further example, the devices 102A-102B may request and/or retrieve one or more files from the storage system 114. The storage system 114 may store information relating to the devices 102A-102B such as the address elements 110A-110B and/or the service elements 112A-112B. As an example, the computing device 104 may obtain the device identifiers 108A-108B from the devices 102A-102B and retrieve information from the storage system 114 such as the address elements 110A-110B and/or the service elements 112A-112B. As a further example, the computing device 104 may obtain the address elements 110A-110B from the devices 102A-102B and may retrieve the service elements 112A-112B from the storage system 114, or vice versa. Any information can be stored in and retrieved from the storage system 114. The storage system 114 can be disposed remotely from the computing device 104 and accessed via direct or indirect connection. The storage system 114 can be integrated with the computing device 104 or some other device or system.

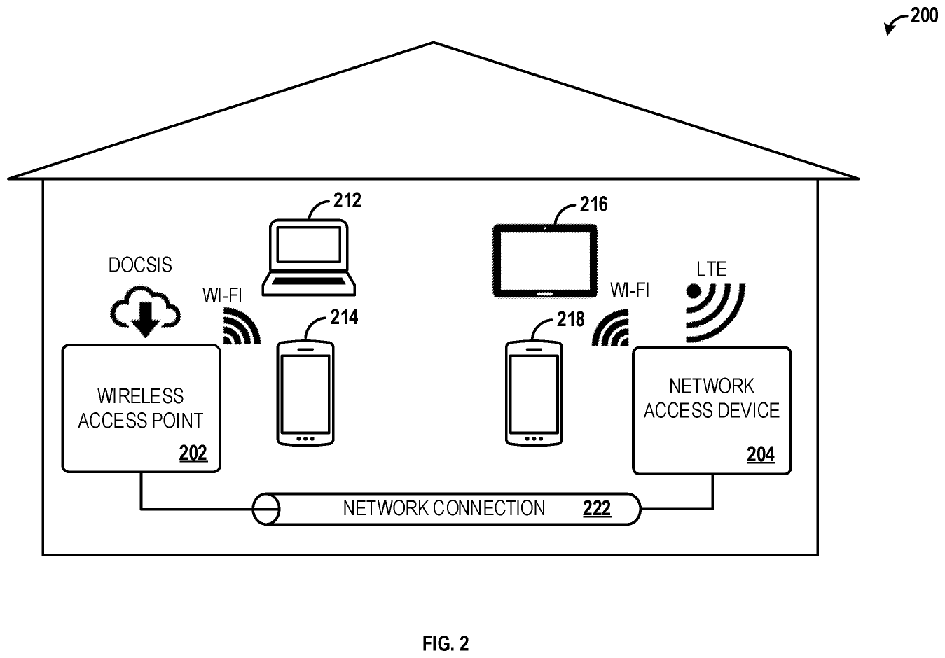

FIG. 2 shows an example scenario 200 wherein a wireless access point (WAP) 202 (e.g., network device 116A, gateway device, etc.) may provide, to one or more user devices (e.g., user devices 212, 214, 216, and 218), access to a wide area network (e.g., the Internet) via a local network (e.g., local area network (LAN)). In addition, a network access device 204 (e.g., network device 116B, Wi-Fi extender device, etc.) may extend coverage of the local network. The WAP 202 and the network access device 204 may be configured as a local network (e.g., LAN) to provide, to the user devices 212, 214, 216, and 218, access to the wide area network via the local network. For example, the WAP 202 may be configured to perform one or more gateway functions of the local network to provide access to the wide area network to the network access device 204 and the user devices 212, 214, 216, and 218. The one or more gateway functions may comprise one or more of network traffic routing, dynamic host configuration protocol (DHCP) management, VoIP functions, or IP streaming functions. As an example, in the absence of a network outage and a power outage, the network access device 204 may be configured as a Wi-Fi extender device for extending the coverage of the local network. The network access device 204 may access the wide area network from the WAP 202 via a network connection 222 (e.g., Wi-Fi connection, LAN tunnel, Ethernet connection, etc.). As shown in FIG. 2, the WAP 202 and the network access device 204 may be placed in different locations of a dwelling. The WAP 202 may provide access to the wide area network to the user devices 212 and 214, while the network access device 204 may provide access to the wide area network (e.g., via the access provided by the WAP 202 via the network connection 222) to the user devices 216 and 218.

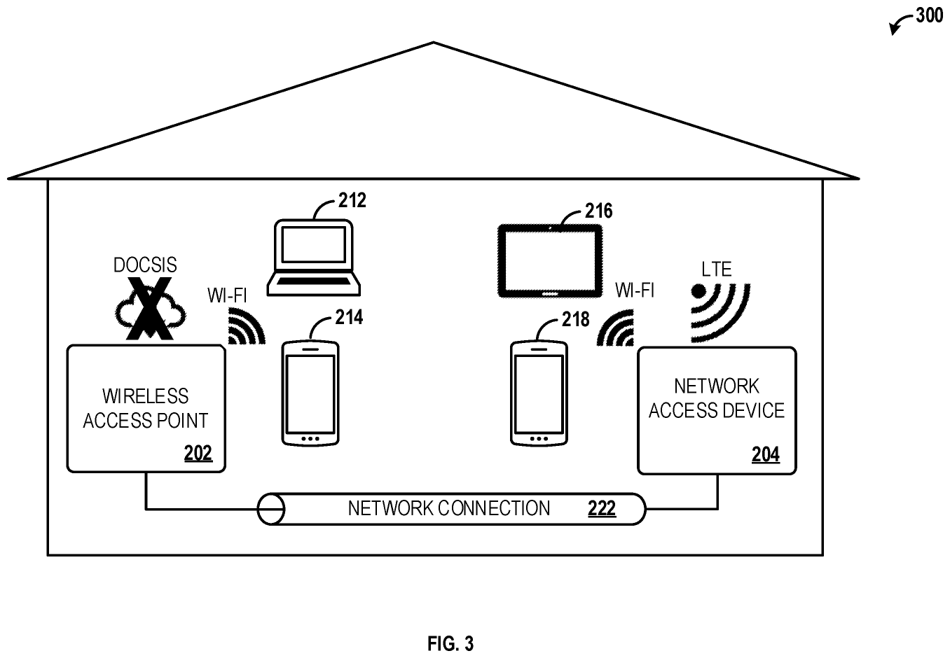

FIG. 3 shows an example scenario 300 wherein the network access device 204 may provide access to the wide area network during an outage. For example, an outage may result from a network outage, wherein the WAP 202 may not be able to access network data packets of the wide area network, or from a power outage, wherein the network access device 204 may not be able to access the wide area network via the WAP 202. The network access device 204 may determine (e.g., detect) a network outage associated with the WAP 202 based on one or more of an absence of network data packets from the WAP 202, an absence of one or more signals from the WAP 202, or a message from the WAP 202. In an example, as shown in FIG. 3, during the network outage, the WAP 202 may no longer have access to the wide area network, such as via a headend or Internet service provider (e.g., such as based on data over cable service interface specification (DOCSIS)). The network access device 204 may access the wide area network via one or more alternative Internet service providers such as a LTE Internet service provider, a cellular Internet service provider, a DSL Internet service provider, a satellite Internet service provider, combinations thereof, and the like. Based on determining the network outage, the network access device 204 may establish a network path between the WAP 202 and the network access device 204. For example, the network path may comprise a wide area network tunnel. In addition, the network access device 204 may be configured to assume (e.g., take over) one or more gateway functions of the WAP 202. For example, the WAP 202 may initially provide the one or more gateway functions prior to the network outage. The network access device 204 may assume the role of the WAP 202 with respect to the one or more gateway functions (e.g., network traffic routing, DHCP management, VoIP functions, or IP streaming functions) during the network outage. The network access device 204 may be configured to maintain a previously existing local area network tunnel (e.g., via the network connection 222) between the WAP 202 and the network access device 204 while establishing the wide area network tunnel. The network access device 204 may provide access to the wide area network to the WAP 202 via the network path based on performing the one or more gateway functions. The WAP 202 may maintain providing access to the wide area network via the local network (e.g., LAN). However, instead of providing access to the wide area network based on receiving the access to the wide area network via the headend, the WAP 202 may provide access to the wide area network based on receiving access to the wide area network via the network access device 204. As an example, the WAP 202 may continue to provide access to the wide area network (e.g., via the access provided by the network access device 204 via the network connection 222) to the user devices 212 and 214, while the network access device 204 may provide access to the wide area network (e.g., via a LTE Internet service provider, a cellular Internet service provider, a DSL Internet service provider, a satellite Internet service provider, combinations thereof, and the like) to the user devices 216 and 218.

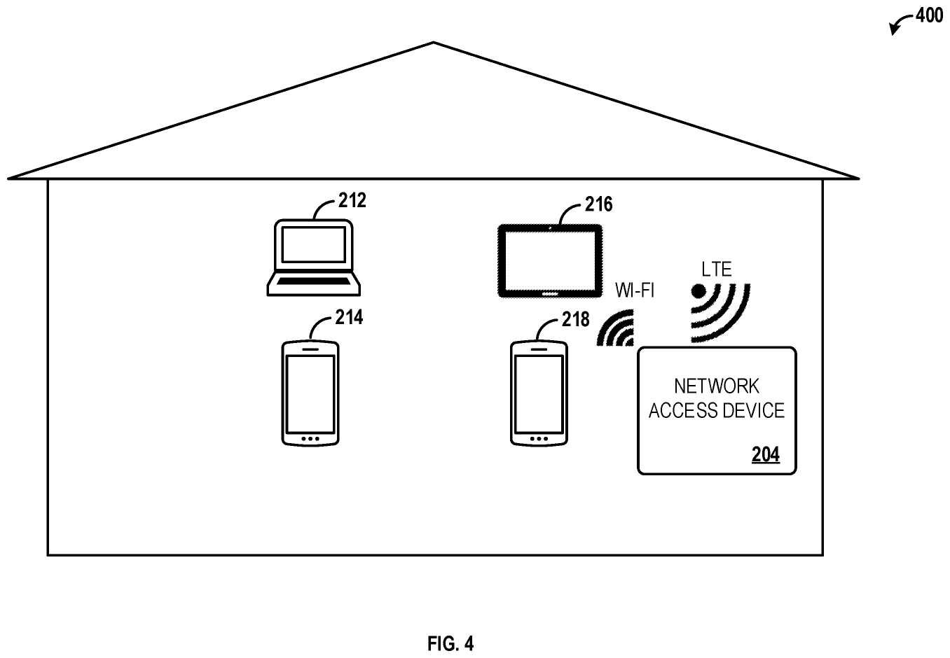

FIG. 4 shows an example scenario 400 wherein the network access device 204 may provide access to the wide area network during an outage. For example, an outage may result from a network outage, wherein the WAP 202 may not be able to access network data packets of the wide area network, or from a power outage, wherein the network access device 204 may not be able to access the wide area network via the WAP 202. The network access device 204 may determine (e.g., detect) a power outage associated with the WAP 202 based on one or more of an absence of network data packets from the WAP 202, an absence of one or more signals from the WAP 202, or a battery of the network access device 204 is no longer charging. In an example, as shown in FIG. 4, during the power outage, the WAP 202 may no longer have access to the wide area network and may no longer provide wireless connection capabilities due to the power outage. The network access device 204 may be configured to access a battery for receiving power in order to continue providing access to the wide area network. For example, the network access device 204 may access the wide area network via one or more alternative Internet service providers such as a LTE Internet service provider, a cellular Internet service provider, a DSL Internet service provider, a satellite Internet service provider, combinations thereof, and the like. Based on the power outage, the network access device 204 may assume the role of the WAP 202 and assume (e.g., take over) one or more gateway functions of the WAP 202 to provide access to the wide area network via the local network to the user devices 212, 214, 216, and 218. For example, the WAP 202 may initially provide the one or more gateway functions prior to the power outage. The network access device 204 may assume the role of the WAP 202 and perform the one or more gateway functions (e.g., network traffic routing, DHCP management, VOIP functions, or IP streaming functions) during the power outage. In an example, based on the power outage, the network access device 204 may discontinue the extension of the coverage of the local network (e.g., LAN) and provide access to the wide area network via the local network to the user devices 212, 214, 216, and 218. For example, the network access device 204 may switch from extending coverage of the local network to assuming the role of the WAP 202 and perform the one or more gateway functions to provide access to the wide area network to the user devices 212, 214, 216, and 218. In an example, the WAP 202 may be configured with a service set identifier (SSID) for facilitating the devices' 102A-102B connection to the wide area network. The network access device 204 may be configured with the same SSID as the WAP 202 to facilitate the connection to the wide area network during the power outage.

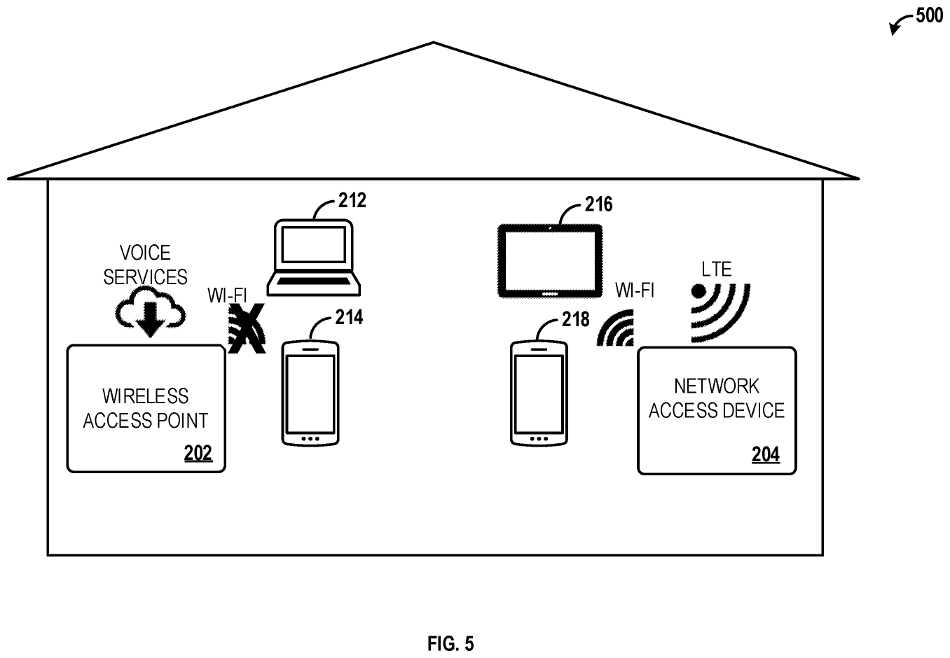

FIG. 5 shows an example scenario 500 wherein the network access device 204 may provide access to the wide area network during an outage. For example, an outage may result from a network outage, wherein the WAP 202 may not be able to access network data packets of the wide area network, or from a power outage, wherein the network access device 204 may not be able to access the wide area network via the WAP 202. The network access device 204 may determine (e.g., detect) a power outage associated with the WAP 202 based on one or more of an absence of network data packets from the WAP 202, an absence of one or more signals from the WAP 202, or a battery of the network access device 204 is no longer charging. A discussed above, the network access device 204 may assume the role of the WAP 202 during the power outage. However, the network access device may be configured to perform some of the gateway functions to provide access to the wide area network to the user devices 212, 214, 216, and 218 during the power outage. For example, the WAP 202 may be configured to provide access to a voice service (e.g., VoIP service). For example, the WAP 202 may be configured to include a battery to provide limited services during a power outage. During the power outage, the WAP 202 may be configured to continue to operate (e.g., in low power mode) in order to provide voice service capabilities/functions. However, the WAP 202 may be configured to restrict access to the wide area network due to operating in the low power mode. Thus, the network access device 204 may perform the other gateway functions (e.g., network traffic routing, DHCP management, or IP streaming functions) to provide access to the wide area network during the power outage.

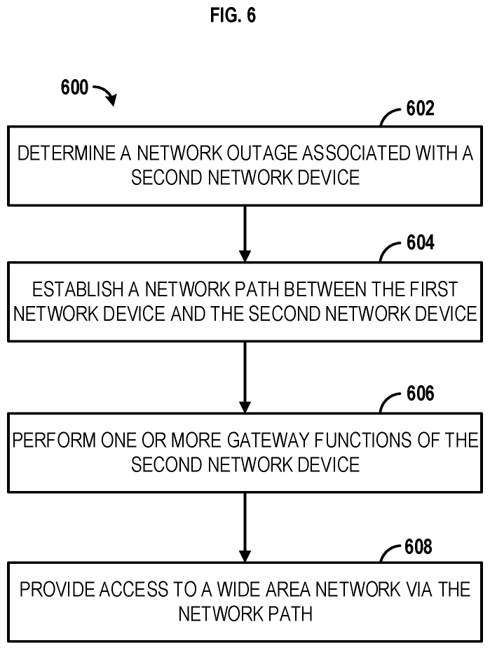

FIG. 6 shows a flowchart of an example method 600 for providing network coverage during a network outage. For example, a network device may be configured to provide back-up access to the wide area network during the network outage. Method 600 may be implemented, for example, by a network device (e.g., network device 116B, network access device 204, Wi-Fi extender device, etc.). At step 602, a network outage may be determined. For example, a first network device (e.g., network device 116B, network access device 204, Wi-Fi extender device, etc.) may determine a network outage associated with a second network device (e.g., network device 116A, wireless access point (WAP) 202, gateway device, etc.). As an example, the second network device may perform one or more gateway functions to provide, to one or more devices connected to the second network device, access to a wide area network via the local network prior to the network outage. For example, the second network device may provide access to the wide area network based on accessing the wide area network via an Internet service provider. The network outage may comprise an outage associated with the Internet, wherein the wide area network may be associated with, or comprise, the Internet. The local network may comprise a local access network (LAN). The one or more gateway functions may comprise one or more of network traffic routing, dynamic host configuration protocol (DHCP) management, VoIP functions, or IP streaming functions. The first network device may be configured as a Wi-Fi extender device for extending the coverage of the local network provided by the second network device, wherein the second network device may comprise a WAP. The network outage may be determined based on one or more of an absence of network data packets from the second network device, an absence of one or more signals from the second network device, or a message from the second network device. For example, the WAP may stop receiving access to the wide area network (e.g., the Internet) based on the network outage.

At step 604, based on the network outage associated with the second network device, a network path may be established between the first network device and the second network device. For example, based on the network outage associated with the second network device, the first network device (e.g., network device 116B, network access device 204, Wi-Fi extender device, etc.) may establish the network path between the first network device and the second network device. The network path between the first network device and the second network device may comprise a wide area tunnel between the first network device and the second network device. For example, the first network device may establish the network path while maintaining a previous network path (e.g., local area network tunnel) between the first network device and the second network device.

At step 606, the one or more gateway functions of the second network device may be performed by the first network device (e.g., network device 116B, network access device 204, Wi-Fi extender device, etc.) based on establishing the network path. For example, the first network device may assume (e.g., take over) the one or more gateway functions initially performed by the second network device. For example, the first network device may assume the role of the second network device with respect to the one or more gateway functions (e.g., network traffic routing, DHCP management, VoIP functions, or IP streaming functions).

At step 608, access to the wide area network via the network path may be provided to the one or more devices connected to the second network device based on performing the one or more gateway functions. For example, the first network device (e.g., network device 116B, Wi-Fi extender device, etc.) may provide, to the one or more devices connected to the second network device, access to the wide area network via the network path based on performing the one or more gateway functions. For example, the first network device may access the wide area network via one or more alternative Internet service providers such as a LTE Internet service provider, a cellular Internet service provider, a DSL Internet service provider, a satellite Internet service provider, combinations thereof, and the like. The first network device may provide the access to the wide area network based on accessing the wide area network via the alternative Internet service provider.

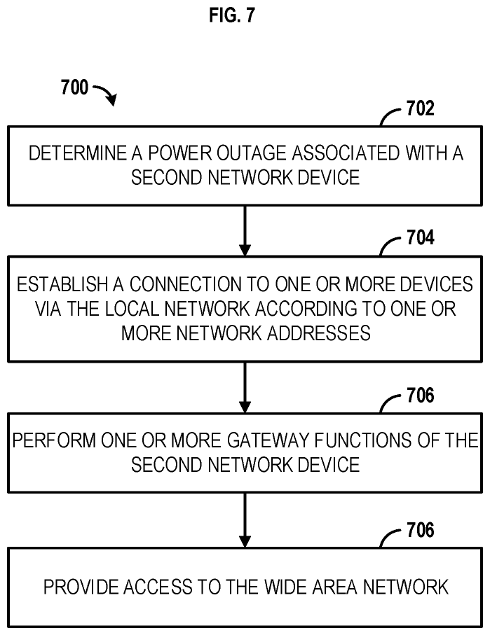

FIG. 7 shows a flowchart of an example method 700 for providing network coverage during a power outage. For example, a network device may be configured to provide back-up access to the wide area network during the power outage. Method 600 may be implemented, for example, by a network device (e.g., network device 116B, network access device 204, Wi-Fi extender device, etc.). At step 702, a power outage may be determined. For example, a first network device (e.g., network device 116B, network access device 204, Wi-Fi extender device, etc.) may determine a power outage associated with a second network device (e.g., network device 116A, wireless access point (WAP) 202, gateway device, etc.). As an example, the second network device may perform one or more gateway functions to provide, to one or more devices connected to the second network device, access to a wide area network via the local network. For example, the second network device may provide access to the wide area network based on accessing the wide area network via an Internet service provider. The second network device may provide access to the wide area network via the local network to the one or more devices according to one or more network addresses. For example, the second network device may provide access to the wide area network via the local network to the one or more devices based on assigning the one or more network addresses to the one or more devices. The first network device may maintain (e.g., store) a record of the one or more network addresses assigned by the second network device. The one or more gateway functions may comprise one or more of network traffic routing, dynamic host configuration protocol (DHCP) management, VoIP functions, or IP streaming functions. The first network device may be configured as a Wi-Fi extender device for extending the coverage of the local network, wherein the second network device may comprise a WAP. The wide area network may be associated with, or comprise, the Internet. The local network may comprise a local access network (LAN). The power outage may be determined based on one or more of an absence of network data packets from the second network device, an absence of one or more signals from the second network device, or a battery of the first network device is no longer charging. For example, during the power outage, the WAP may no longer have access to the wide area network and may no longer provide wireless connection capabilities due to the power outage.

At step 704, based on the power outage associated with the second network device, the first network device (e.g., network device 116B, network access device 204, Wi-Fi extender device, etc.) may established a connection to the one or more devices via the local network according to the one or more network addresses. For example, the first network device may establish the connection with the one or more devices based on the one or more network addresses maintained (e.g., stored) by the first network device. In an example, based on the power outage associated with the second network device, the first network device may discontinue the extension of the coverage of the local network.

At step 706, the one or more gateway functions of the second network device may be performed by the first network device (e.g., network device 116B, network access device 204, Wi-Fi extender device, etc.) based on establishing the connection to the one or more devices. For example, the first network device may assume (e.g., take over) the role of the second network device and perform the one or more gateway functions initially performed by the second network device. For example, the first network device may switch from extending coverage of the local network to assuming the role of the second network device and provide the one or more gateway functions. In an example, the second network device may be configured with a service set identifier (SSID) for facilitating the connection of the one or more device to the wide area network. The first network device may be configured with the same SSID as the second network device to facilitate the connection to the wide area network during the power outage. For example, during the power outage, the one or more devices may automatically connect to the first network device via the SSID.

At step 708, access to the wide area network via the local network may be provided to the one or more devices based on performing the one or more gateway functions. For example, the first network device (e.g., network device 116B, network access device 204, Wi-Fi extender device, etc.) may provide, to the one or more devices, access to the wide area network via the local network based on performing the one or more gateway functions. For example, the first network device may access the wide area network via one or more alternative Internet service providers such as a LTE Internet service provider, a cellular Internet service provider, a DSL Internet service provider, a satellite Internet service provider, combinations thereof, and the like. The first network device may provide the access to the wide area network based on accessing the wide area network via the alternative Internet service provider.

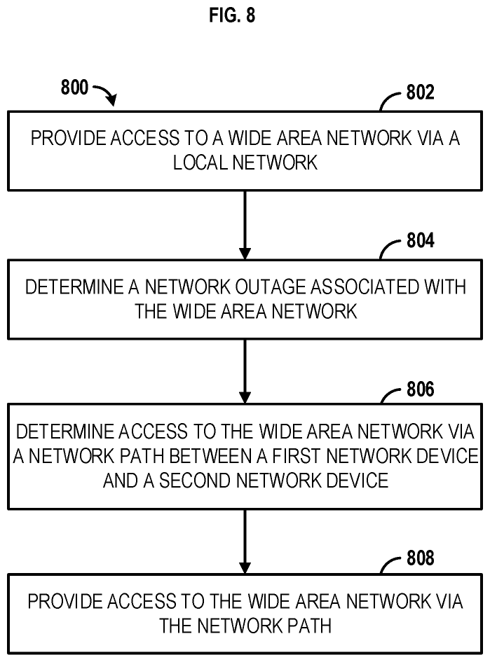

FIG. 8 shows a flowchart of an example method 800 for providing network coverage during a network outage. For example, a network device may be configured to receive access to the wide area network during the network outage. Method 800 may be implemented, for example, by a network device (e.g., network device 116A, wireless access point (WAP) 202, gateway device, etc.). At step 802, access to a wide area network via a local network may be provided to one or more devices based on performing one or more gateway functions. For example, a first network device (e.g., network device 116A, WAP 202, gateway device, etc.) may provide, to the one or more user devices, access to the wide area network via the local network based on performing the one or more gateway functions. The one or more gateway functions may comprises one or more of network traffic routing, dynamic host configuration protocol (DHCP) management, VoIP functions, or IP streaming functions. The first network device may provide access to the wide area network based on accessing the wide area network via an Internet service provider. In an example, a second network device (e.g., a Wi-Fi extender device) may extend coverage of the local network. The wide area network may be associated with, or comprise, the Internet. The local network may comprise a LAN.

At step 804, a network outage associated with the wide area network may be determined. For example, the first network device (e.g., network device 116A, WAP 202, gateway device, etc.) may determine the network outage associated with the wide area network. The network outage may be determined based on an absence of network packets via the wide area network.

At step 806, based on the network outage associated with the wide area network, access to the wide area network via a network path between the first network device and the second network device may be determined. For example, based on the network outage associated with the wide area network, the first network device (e.g., network device 116A, WAP 202, gateway device, etc.) may determine the access to the wide area network via the network path between the first network device and the second network device. As an example, the second network device may establish the network path between the first network device and the second network device. For example, the second network device may perform the one or more gateway functions of the first network device based on establishing the network path during the network outage. The network path may comprise a wide area network tunnel. The second network device may be configured to maintain a previously existing local area network tunnel between the first network device and the second network device while establishing the wide area network tunnel. The first network device may maintain the local network with the one or more devices based on receiving access to the wide area network via the network path. For example, the second network device may access the wide area network via one or more alternative Internet service providers such as a LTE Internet service provider, a cellular Internet service provider, a DSL Internet service provider, a satellite Internet service provider, combinations thereof, and the like. The second network device may provide, to the first network device, access to the wide area network based on accessing the wide area network via the alternative Internet service provider. In an example, the second network device may comprise a Wi-Fi extender device that may be configured to provide access to the wide area network during the network outage.

At step 808, access to the wide area network via the network path may be provided. For example, the first network device (e.g., network device 116A, WAP 202, gateway device, etc.) may provide the access to the wide area network via the network path. For example, during the network outage, the second network device may assume (e.g., take on) the one or more gateway functions initially performed by the first network device to provide access to the wide area network to the one or more devices prior to the network outage. For example, during the network outage, the second network device may be configured to discontinue extension of the local network and assume the role of the second network device with respect to the one or more gateway functions (e.g., network traffic routing, DHCP management, VOIP functions, or IP streaming functions) to provide access to the wide area network to the one or more devices.

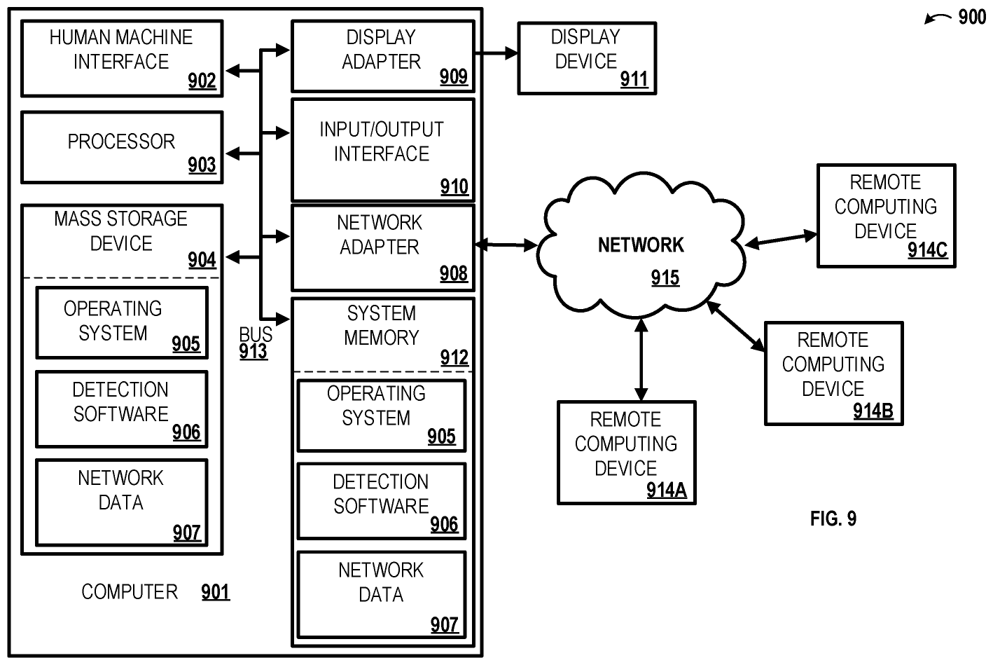

FIG. 9 is a block diagram illustrating an example computing device. The methods and systems can be implemented on a computer 901 as illustrated in FIG. 9 and described below. By way of example, user device 102A-102B, the network devices 116A-116B, and computing device 104 of FIG. 1 can be a computer 901 as illustrated in FIG. 9. Similarly, the methods and systems disclosed can utilize one or more computers to perform one or more functions in one or more locations. FIG. 9 is a block diagram illustrating an exemplary operating environment 900 for performing the disclosed methods. This exemplary operating environment 900 is only an example of an operating environment and is not intended to suggest any limitation as to the scope of use or functionality of operating environment architecture. Neither should the operating environment 900 be interpreted as having any dependency or requirement relating to any one or combination of components illustrated in the exemplary operating environment 900.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media including memory storage devices.

Further, one skilled in the art will appreciate that the systems and methods disclosed herein can be implemented via a general-purpose computing device in the form of a computer 901. The computer 901 can comprise one or more components, such as one or more processors 903, a system memory 912, and a bus 913 that couples various components of the computer 901 including the one or more processors 903 to the system memory 912. In the case of multiple processors 903, the system can utilize parallel computing.

The bus 913 can comprise one or more of several possible types of bus structures, such as a memory bus, memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 913, and all buses specified in this description can also be implemented over a wired or wireless network connection and one or more of the components of the computer 901, such as the one or more processors 903, a mass storage device 904, an operating system 905, detection software 906, network data 907, a network adapter 908, system memory 912, an Input/Output Interface 910, a display adapter 909, a display device 911, and a human machine interface 902, can be contained within one or more remote computing devices 914A-914C at physically separate locations, connected through buses of this form, in effect implementing a fully distributed system.

The computer 901 typically comprises a variety of computer readable media. Exemplary readable media can be any available media that is accessible by the computer 901 and comprises, for example and not meant to be limiting, both volatile and non-volatile media, removable and non-removable media. The system memory 912 can comprise computer readable media in the form of volatile memory, such as random access memory (RAM), and/or non-volatile memory, such as read only memory (ROM). The system memory 912 typically can comprise data such as network data 907 and/or program modules such as operating system 905 and detection software 906 that are accessible to and/or are operated on by the one or more processors 903.

The computer 901 can also comprise other removable/non-removable, volatile/non-volatile computer storage media. By way of example, the computer 901 can comprise a mass storage device 904 which can offer non-volatile storage of computer code, computer readable instructions, data structures, program modules, and other data for the computer 901. For example, a mass storage device 904 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 904, including by way of example, an operating system 905 and detection software 906. One or more of the operating system 905 and detection software 906 (or some combination thereof) can comprise elements of the programming and the detection software 906. Network data 907 can also be stored on the mass storage device 904. Network data 907 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple locations within the network 915.

The user can enter commands and information into the computer 901 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices can be connected to the one or more processors 903 via a human machine interface 902 that is coupled to the bus 913, but can be connected by other interface and bus structures, such as a parallel port, game port, an IEEE 1394 Port (also known as a Firewire port), a serial port, network adapter 908, and/or a universal serial bus (USB).

A display device 911 can also be connected to the bus 913 via an interface, such as a display adapter 909. It is contemplated that the computer 901 can have more than one display adapter 909 and the computer 901 can have more than one display device 911. For example, a display device 911 can be a monitor, an LCD (Liquid Crystal Display), light emitting diode (LED) display, television, smart lens, smart glass, and/or a projector. In addition to the display device 911, other output peripheral devices can comprise components such as speakers (not shown) and a printer (not shown) which can be connected to the computer 901 via Input/Output Interface 910. Any step and/or result of the methods can be output in any form to an output device. Such output can be any form of visual representation, including, but not limited to, textual, graphical, animation, audio, tactile, and the like. The display 911 and computer 901 can be part of one device, or separate devices.

The computer 901 can operate in a networked environment using logical connections to one or more remote computing devices 914A, 914B, and 914C. By way of example, a remote computing device 914A-914C can be a personal computer, a computing station (e.g., a workstation), a portable computer (e.g., a laptop, a mobile phone, a tablet device), a smart device (e.g., a smartphone, a smart watch, an activity tracker, a smart apparel, a smart accessory), a security and/or monitoring device, a server, a router, a network computer, a peer device, an edge device or other common network node, and so on. Logical connections between the computer 901 and a remote computing device 914A-914C can be made via a network 915, such as a local area network (LAN) and/or a general wide area network (WAN). Such network connections can be through a network adapter 908. A network adapter 908 can be implemented in both wired and wireless environments. Such networking environments are conventional and commonplace in dwellings, offices, enterprise-wide computer networks, intranets, and the Internet.

For purposes of illustration, application programs and other executable program components such as the operating system 905 are illustrated herein as discrete blocks, although it is recognized that such programs and components can reside at various times in different storage components of the computer 901, and are executed by the one or more processors 903 of the computer 901. An implementation of detection software 906 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence (AI) techniques such as machine learning and iterative learning. Examples of such techniques include, but are not limited to, expert systems, case based reasoning, Bayesian networks, behavior based AI, neural networks, fuzzy systems, evolutionary computation (e.g., a genetic algorithms), swarm intelligence (e.g., an ant algorithms), and hybrid intelligent systems (e.g., expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method comprising:
determining, by a first network device, a network outage associated with a second network device, wherein the second network device performs one or more gateway functions to provide, to one or more devices connected to the second network device, access to a wide area network via a local network prior to the network outage;
based on the network outage associated with the second network device, establishing a network path between the first network device and the second network device;
performing, based on establishing the network path, the one or more gateway functions of the second network device; and
providing, to the one or more devices connected to the second network device, based on performing the one or more gateway functions, access to the wide area network via the network path.

2. The method of claim 1, wherein the network outage comprises an outage associated with the Internet.

3. The method of claim 1, further comprising determining the network outage associated with the second network device based on one or more of an absence of network data packets from the second network device, an absence of one or more signals from the second network device, or a message from the second network device.

4. The method of claim 1, wherein the network path between the first network device and the second network device comprises a wide area network tunnel between the first network device and the second network device.

5. The method of claim 1, wherein the network path between the first network device and the second network device is established while a previous network path is maintained between the first network device and the second network device.

6. The method of claim 1, wherein the one or more gateway functions comprise one or more of network traffic routing, dynamic host configuration protocol (DHCP) management, VoIP functions, or IP streaming functions.

7. The method of claim 1, wherein the first network device is configured to extend coverage of the local network prior to the network outage.

8. A method comprising:
determining, by a first network device, a power outage associated with the second network device, wherein the second network device performs one or more gateway functions to provide, to one or more devices connected to the second network device, access to a wide area network via a local network according to one or more network addresses prior to the power outage;
based on the power outage associated with the second network device, establishing a connection to the one or more devices via the local network according to the one or more network addresses;
performing, based on establishing the connection to the one or more devices, the one or more gateway functions of the second network device; and
providing, to the one or more devices, based on performing the one or more gateway functions, access to the wide area network.

9. The method of claim 8, wherein the wide area network is associated with the Internet.

10. The method of claim 8, further comprising determining the power outage associated with the second network device based on one or more of an absence of network data packets from the second network device, an absence of one or more signals from the second network device, or a battery of the first network device is no longer charging.

11. The method of claim 8, wherein the one or more gateway functions comprise one or more of network traffic routing, dynamic host configuration protocol (DHCP) management, VoIP functions, or IP streaming functions.

12. The method of claim 8, wherein the second network device assigns the one or more network addresses to the one or more devices, wherein the first network device maintains a record of the one or more network addresses assigned by the second network device to the one or more devices.

13. The method of claim 8, wherein the first network device is configured to extend coverage of the local network prior to the power outage.

14. A method comprising:
providing, by a first network device, to one or more devices, based on performing one or more gateway functions, access to a wide area network via a local network;
determining a network outage associated with the wide area network;
based on the network outage associated with the wide area network, determining access to the wide area network via a network path between the first network device and a second network device, wherein the second network device performs the one or more gateway functions of the first network device based on the network outage; and
providing, to the one or more devices, access to the wide area network via the network path.

15. The method of claim 14, wherein the network outage comprises an outage associated with the Internet.

16. The method of claim 14, further comprising determining the network outage associated with the wide area network based on an absence of network packets via the wide area network.

17. The method of claim 14, wherein the second network device establishes the network path between the first network device and the second network device.

18. The method of claim 14, wherein the network path between the first network device and the second network device is established while a previous network path is maintained between the first network device and the second network device.

19. The method of claim 14, wherein the one or more gateway functions comprise one or more of network traffic routing, dynamic host configuration protocol (DHCP) management, VoIP functions, or IP streaming functions.

20. The method of claim 14, wherein the second network device is configured to extend coverage of the local network prior to the network outage.
